(19) United States
(12) Patent Application Publication
(10) Pub. No.: US 2021/0303642 A1
(43) Pub. Date: Sep. 30, 2021

(54) Methods And Computer Programs For Processing Online Jobs

(71) Applicant: TMAXSOFT CO., LTD, Gyeonggi-do (KR)

(72) Inventors: Sooyong LEE, Gyeonggi-do (KR); Seongbai JUN, Gyeonggi-do (KR); Sangho KIM, Gyeonggi-do (KR)

(73) Assignee: TMAXSOFT CO., LTD, Gyeonggi-do (KR)

(21) Appl. No.: 16/831,064

(22) Filed: Mar. 26, 2020

(30) Foreign Application Priority Data
Mar. 24, 2020 (KR) 10-2020-0035339

(51) Int. Cl. G06F 16/953

(52) U.S. Cl. CPC G06F 16/953

(57) ABSTRACT

According to an exemplary embodiment of the present disclosure, a computer program stored in a computer-readable storage medium is disclosed. The computer program includes commands which cause a processor of a server to execute operations below, the operations including: accessing a database including meta-information related to an online job in order not to use a batch system when processing the online job associated with an online program; reading the meta-information related to the online job from the database; and processing an online transaction related to the online program by using the meta-information related to the online job.

### TECHNICAL FIELD

The present disclosure relates to a method and a computer program for processing an online job, and more particularly, to a method and a computer program for processing an online job in an open environment.

### BACKGROUND ART

A main frame system was widely introduced by the government, financial institutions, and large companies in the 1960s and 1970s to process various data necessary for business activities. The main frame system means a large-scale general-purpose computer that performs various jobs by adopting a centralized method of connecting multiple terminals to one computer. For example, System/360 of IBM Company and the like correspond to the main frame system. The main frame system has continued to grow while leading the enterprise's computing industry for nearly 30 years. However, in the late 80s, a distributed environment in an open system, such as a Unix platform, emerged, and the trend of downsizing to the open system for reducing system operating costs caused the position of the main frame system to be greatly questioned.

Unlike the main frame system, the open system refers to a system that can be connected with or ported with other types of computers because the interface is open without depending on a specific company's closed technology and programs, and includes, for example, UNIX. Recently, the popularity of the open system continues, but the current open system uses a batch system like the existing main frame system, for job processing.

Particularly, when the open system uses the batch system in processing an online job, a flexible restart may be difficult in a situation, such as an abnormal termination of the process. Particularly, even though only one process among several task processes is abnormally terminated, a user needs to manually restart all processes included in a corresponding job.

Accordingly, there is a need for research on a method of solving inconvenience generated due to the batch system used in the open system.

### RELATED ART LITERATURE

### Patent Document

Korean Patent No. 10-1997494

### SUMMARY OF THE INVENTION

The present disclosure is conceived in response to the background art, and has been made to provide a method and a computer program for processing an online job without a batch system.

The technical objects of the present disclosure are not limited to the foregoing technical objects, and other non-mentioned technical objects will be clearly understood by those skilled in the art from the description below.

An exemplary embodiment of the present disclosure for solving the problem discloses a computer program stored in a computer readable storage medium. The computer program includes commands which cause a processor of a server to execute operations below, the operations including; accessing a database including meta-information related to an online job in order not to use a batch system when processing the online job associated with an online program; reading the meta-information related to the online job from the database; and processing an online transaction related to the online program by using the meta-information related to the online job.

When migration of a job control language associated with the online program is performed, the meta-information related to the online job may be generated by statically analyzing a job control language and stored in the database.

The migration may be performed by migration operations below, the migration operations including: obtaining a job control language for a main frame executed in a job entry subsystem environment of the main frame; and converting the job control language for the main frame written based on the Extended Binary Coded Decimal Interchange Code (EBCDIC) used in the main frame to a job control language based on the American Standard Code for Information Interchange (ASCII) code used in an open system.

The meta-information related to the online job may include at least one of scheduling information in a transaction unit for processing the online job, information on an execution program related to the online job, location information on the execution program, a dataset name related to the online job, location information on the dataset, information on an allocation method of the dataset, or information on an input/output device to be used.

The reading of the meta-information related to the online job from the database may include: when the online program is executed, recognizing an online job name based on a command requesting execution of the online job associated with the online program; and reading the meta-information related to the online job by using the online job name.

The reading of the meta-information related to the online job by using the online job name may include: if the online job name is a first online job name, reading first meta-information that is mapped to the first online job name and stored in the database. The processing of the online transaction associated with the online program by using the meta-information related to the online job may include setting a resource for performing the online job by using the meta-information; and processing the online transaction by using the resource.

The setting of the resource for performing the online job by using the meta-information may include: extracting a resource corresponding to the online job from the meta-information; and processing the online transaction by executing an execution program included in the resource.

The operations may further include: detecting whether the online program is abnormally terminated; re-reading the meta-information related to an online job of the online program by accessing the database when abnormal termination of the online program is detected; and re-processing the online transaction related to an abnormally terminated online program by using the meta-information.

Another exemplary embodiment of the present disclosure for solving the problem discloses a method of processing an online job. The method may include: accessing a database including meta-information related to an online job in order not to use a batch system when processing the online job associated with an online program; reading the meta-information related to the online job from the database; and processing an online transaction related to the online program by using the meta-information related to the online job.

When migration of a job control language associated with the online program is performed, the meta-information related to the online job may be generated by statically analyzing a job control language and stored in the database.

The migration may be performed by migration operations below, the migration operations including: obtaining a job control language for a main frame executed in a job entry subsystem environment of the main frame; and converting the job control language for the main frame written based on the Extended Binary Coded Decimal Interchange Code (EBCDIC) used in the main frame to a job control language based on the American Standard Code for Information Interchange (ASCII) code used in an open system.

The meta-information related to the online job may include at least one of scheduling information in a transaction unit for processing the online job, information on an execution program related to the online job, location information on the execution program, a dataset name related to the online job, location information on the dataset, information on an allocation method of the dataset, or information on an input/output device to be used.

The reading of the meta-information related to the online job by using the online job name may include: when the online program is executed, recognizing an online job name based on a command requesting execution of the online job associated with the online program; and reading the meta-information related to the online job by using the online job name.

The reading of the meta-information related to the online job by using the online job name may include: if the online job name is a first online job name, reading first meta-information that is mapped to the first online job name and stored in the database

The processing of the online transaction associated with the online program by using the meta-information related to the online job may include setting a resource for performing the online job by using the meta-information; and processing the online transaction by using the resource.

The setting of the resource for performing the online job by using the meta-information may include: extracting a resource corresponding to the online job from the meta-information; and processing the online transaction by executing an execution program included in the resource.

The method may further include: detecting whether the online program is abnormally terminated; re-reading the meta-information related to an online job of the online program by accessing the database when abnormal termination of the online program is detected; and re-processing the online transaction related to an abnormally terminated online program by using the meta-information.

The technical solutions obtainable from the present disclosure are not limited to the foregoing solutions, and other non-mentioned solution will be clearly understood by those skilled in the art from the description below.

The present disclosure provides a method and a computer program for processing an online job without a batch system, thereby solving the inconvenience generated due to the batch system used in an open system.

The effects obtainable from the present disclosure are not limited to the foregoing effects, and other non-mentioned effects will be clearly understood by those skilled in the art from the description below.

### BRIEF DESCRIPTION OF THE DRAWINGS

Various aspects are described with regarding the drawings, and herein, like reference numerals are generally used to designate like constituent elements. In the exemplary embodiment below, for description, a plurality of specific and detailed matters is suggested to provide a general understanding of one or more aspects. However, the aspect(s) may be carried out without the specific and detailed matters.

FIG. 1 is a diagram for describing a system for performing an online job without a batch system according to exemplary embodiments of the present disclosure.

FIG. 2 is a flowchart for describing an example of a method of processing an online job by a server according to exemplary embodiments of the present disclosure.

FIG. 3 is a flowchart for describing an example of a migration method according to exemplary embodiments of the present disclosure.

FIG. 4 is a flowchart for describing an example of a method of reading, by the server, meta-information related to an online job in a database according to exemplary embodiments of the present disclosure.

FIG. 5 is a flowchart for describing an example of a method of processing, by the server, an online transaction related to an online program by using meta-information related to an online job according to exemplary embodiments of the present disclosure.

FIG. 6 is a simple and general schematic diagram illustrating an example of a computing environment in which exemplary embodiments of the present disclosure are implementable.

### DETAILED DESCRIPTION

Various exemplary embodiments and/or aspects are now disclosed regarding the drawings. In the description below, the plurality of particular detailed matters is disclosed for helping general understanding of one or more aspects for description. However, the point that the aspect(s) is executable even without the particular detailed matters may also be recognized by those skilled in the art. The subsequent description and the accompanying drawings describe specific illustrative aspects of one or more aspects in detail. However, the aspects are illustrative, and some of the various methods of various aspects of the principles may be used, and the descriptions intend to include the aspects and the equivalents thereof. Particularly, an “exemplary embodiment”, an “example”, an “aspect”, an “illustration”, and the like used in the present specification may not be construed to be better or have an advantage compared to a predetermined described aspect, an aspect having a different design, or designs.

Various aspects and characteristics may be presented by a system including one or more apparatuses, terminals, servers, devices, components, and/or modules. The point that various systems may include additional apparatuses, terminals, servers, devices, components, and/or modules, and/or the point that the various systems may not include all of the apparatuses, terminals, servers, devices, components, modules, and the like discussed about the drawings shall also be understood and recognized.

Terms, “computer program”, “component”, “module”, “system”, and the like used in the present specification are compatibly usable with one another, and indicate a computer-related entity, hardware, firmware, software, a combination of software and hardware, or execution of software. For example, a component may be a procedure, a processor, an object, an execution thread, a program, and/or a computer-executed in a processor, but is not limited thereto. For example, both an application executed in a computing device and the computing device may be components. One or more components may reside within a processor and/or an execution thread. One component may be localized within one computer and another component may be distributed between two or more computers.

The components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Hereinafter, the same or similar constituent element is denoted by the same reference numeral regardless of a reference numeral, and a repeated description thereof will be omitted. Further, in describing the exemplary embodiment disclosed in the present disclosure, when it is determined that detailed description relating to well-known functions or configurations may make the subject matter of the exemplary embodiment disclosed in the present disclosure ambiguous, the detailed description will be omitted. Further, the accompanying drawings are provided for helping to easily understand exemplary embodiments disclosed in the present specification, and the technical spirit disclosed in the present specification is not limited by the accompanying drawings.

A term used in the present specification is for describing the exemplary embodiments, and does not intend to limit the present disclosure. In the present specification, a singular form includes plural forms as well, unless otherwise mentioned. A term “comprises” and/or “comprising” used in the specification does not exclude the existence or an addition of one or more other constituent elements, in addition to the mentioned constituent element.

Although “a first”, “a second”, and the like are used for describing various elements or constituent elements, but the elements or the constituent elements are not limited by the terms. The terms are used for discriminating one element or constituent element from another element or constituent element. Accordingly, a first element or constituent element mentioned below may also be a second element or constituent element within the technical spirit of the present disclosure as a matter of course.

Unless otherwise defined, all of the terms (including technical and scientific terms) used in the present specification may be used as a meaning commonly understood by those skilled in the art. Further, terms defined in a generally used dictionary shall not be construed as being ideal or excessive in meaning unless they are clearly defined.

Further, a term “or” intends to mean comprehensive “or”, not exclusive “or”. That is, unless otherwise specified or when it is unclear in context, “X uses A or B” intends to mean one of the natural comprehensive substitutions. That is when X uses A, X uses B, or X uses both A and B, “X uses A or B” may be applied to anyone among the cases. Further, a term “and/or” used in the present specification shall be understood to designate and include all of the possible combinations of one or more items among the listed relevant items.

Also, the terms “information” and “data” used in the present specification may be frequently used to be exchangeable with each other.

Suffixes, “ . . . module” and “ . . . unit” for a constituent element used for the description below are given or mixed in consideration of only easiness of the writing of the specification, and the suffix itself does not have a discriminated meaning or role.

An object and an effect of the present disclosure, and technical configurations for achieving them will be apparent when the exemplary embodiments, which are described below in detail together with the accompanying drawing, are referred. In the description of the present disclosure, when a detailed description of a related publicly known function or configuration is determined to unnecessarily make the subject matter of the present disclosure unclear, the detailed description will be omitted. Further, terms described below are terms set in consideration of a function in the present disclosure, and may be changed according to an intention of a user and an operator or a usual practice.

However, the present disclosure is not limited to the exemplary embodiments disclosed below, and may be implemented in different forms. However, the present exemplary embodiments are provided to make the present disclosure complete and to completely transfer the scope of the disclosure to those skilled in the art, and the present disclosure is simply defined by the claims. Accordingly, the definitions thereof should be made based on the entire contents of the present specification.

The scope of the operations in the claims of the present disclosure is generated by the functions and the characteristics, described in each of the operations, and is not influenced by a description order of each operation in the claims unless the order of precedence is specified in the operations of the method. For example, in the claim of the method including operation A and operation B, even though operation A is written before operation B, the scope is not limited to that operation A should precede operation B.

In the contents of the present disclosure, a job control language notifies an operating system of what to do to process data. The job control language is formed of job control language statement having a series of rules and may instruct the operating system about what processing to be performed, that is, which program is executed, which resource is required by the program, by the job control language statement.

The job control language statement may perform the following functions. The job control language statement hands a job to the operating system. Further, the job control language statement presents what to do to the operating system. The job control language statement also demands an allocation of a hardware device to the operating system for a specific dataset and designates a program to be executed.

Herein, the dataset may mean a set of logically connected data records. The record means a basic unit of information used in an application. Further, the dataset may be divided into a Non-VSAM dataset and a VSAM dataset according to the type. However, the present disclosure is not limited thereto.

A series of jobs submitted to the operating system by a user for performance is referred to as an input job stream. The input job stream consists of one or a plurality of jobs, and one job consists of one or a plurality of steps. Each job may be formed of the following job control language statement. For example, the job control language statement may include “Job Statement” indicating a start of a job, one or more “EXEC Statements” indicating a start of the step, “DD Statement” defining a dataset required for performing the job step, and “Delimiter Statement” indicating input data and termination of the input data.

One step is a minimum job unit that needs to be performed in the same processor in a system including multiple processors (CPUs). That is, one step cannot be divided into multiple sub-steps and performed in parallel. The steps in the same job may be performed in parallel by a high-tech system processing method. However, whether to perform and the parallel performance level are determined by a system environment and a job characteristic.

“Job Statement” notifies the operating system of the start of the job. “Job Statement” may designate information for dividing the job and a parameter required for executing the job. Further, one job is terminated at a point at which a next Job Statement is found or NULL Statement is found.

The job step starts with an EXEC statement that specifies the name of the program to be executed. One job includes one or a plurality of job steps. One job step is terminated where a next EXEC Statement, Job Statement, or NULL Statement is met.

“DD Statement” designates a dataset (similar to a file in a UNIX server and the like) required by the program. One dataset designates one DD Statement. “DD Statement” designates a dataset name to be used, an input/output device to be used, a location of a dataset, an allocation method, other dataset characteristics, and the like.

Hereinafter, exemplary embodiments of the present disclosure will be described in more detail about the accompanying drawings.

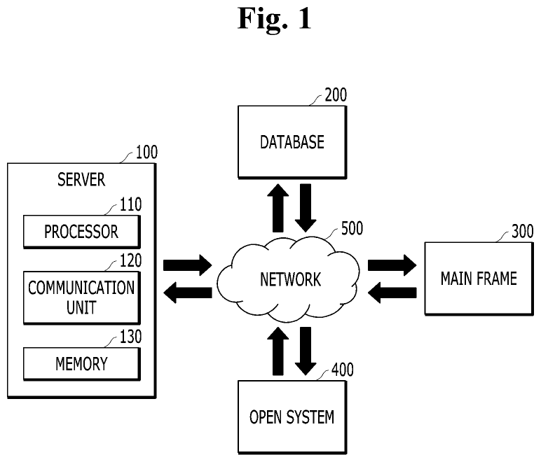

FIG. 1 is a diagram for describing a system for performing an online job without a batch system according to exemplary embodiments of the present disclosure.

Referring to FIG. 1, a system for performing an online job without a batch system may include a server 100, a database 200, a main frame 300, an open system 400, and a network 500. However, the constituent elements are not essential for implementing the system for performing the online job without the batch system, so that the system may include more or less constituent elements than the above-listed constituent elements.

According to the exemplary embodiments of the present disclosure, the server 100 may be related to a user who desires to execute a specific program (particularly, an online program). Particularly, when the server 100 receives an execution request of a specific program from a user, the server 100 may process a transaction related to the specific program by using a job control language related to the specific program.

The server 100 may include a predetermined type of computer system or computing device, such as a microprocessor, a main frame computer, a digital processor, a portable device, and a device controller. However, the present disclosure is not limited thereto, the server 100 may include a mobile phone, a smartphone, a notebook computer (laptop computer), a digital broadcasting terminal, personal digital assistants (PDA), a portable multimedia player (PMP), a navigation device a slate personal computer (PC), a tablet PC, an ultrabook, a wearable device, for example, a watch-type terminal (smartwatch), a glass type terminal (smart glass), and a head-mounted display (HMD), and the like.

According to the exemplary embodiments of the present disclosure, the server 100 may include a processor 110, a communication unit 120, and a memory 130. However, the constituent elements are not essential for implementing the server 100, so that the server 100 may have the constituent elements more or less than the listed constituent elements.

First, the communication unit 120 of the server 100 may include one or more modules capable of establishing communication between the server 100 and the database 200, between the server 100 and the main frame 300, and between the server 100 and the open system 400. Further, the communication unit 120 may include one or more modules connecting the server 100 to one or more networks.

The network 500 establishing communication between the server 100 and the database 200, between the server 100 and the main frame 300, and between the server 100 and the open system 400 may use various wired communication systems, such as a Public Switched Telephone Network (PSTN), an x Digital Subscriber Line (xDSL), a Rate Adaptive DSL (RADSL), a Multi-Rate DSL (MDSL), a Very High-speed DSL (VDSL), a Universal Asymmetric DSL (UADSL), a High Bit-Rate DSL (HDSL), and a Local Area Network (LAN).

The network 500 presented herein may use various wireless communication systems, such as code division multi-access (CDMA), time division multi-access (TDMA), frequency division multi-access (FDMA), orthogonal frequency division multi-access (OFDMA), single carrier-FDMA (SC-FDMA), and other systems.

The network 500 according to the exemplary embodiments of the present disclosure may be configured regardless of a communication aspect, such as a wired aspect and a wireless aspect, and may be configured by various communication networks, such as a personal area network (PAN) and a wide area network (WAN). Further, the network 500 may be a publicly known World Wide Web (WWW), and may also use a wireless transmission technology used in short-range communication, such as Infrared Data Association (IrDA) or Bluetooth.

The technologies described in the present specification may also be used in other networks, as well as the foregoing networks.

In the meantime, the memory 130 of the server 100 may store a program for an operation of the processor 110, and may also temporarily or persistently store input/output data. The memory 130 may include at least one type of storage medium among a flash memory type, a hard disk type, a multimedia card micro type, and the card type of memory (for example, an SD or XD memory), a Random Access Memory (RAM), a Static Random Access Memory (SRAM), a Read-Only Memory (ROM), an Electrically Erasable Programmable Read-only Memory (EEPROM), a Programmable Read-Only Memory (PROM), a magnetic memory, a magnetic disk, and an optical disk. The memory 130 may be operated under the control of the processor 110.

The processor 110 of the server 100 may usually control the general operation of the server 100. The processor 110 may provide a user with the appropriate information or function or process the appropriate information or function by processing the signal, data, information, and the like input or output through the constituent elements or driving the application program stored in the memory 130.

The processor 110 may control at least a part of the constituent elements described regarding FIG. 1 to drive an application program stored in the memory 130. Further, the processor 110 may combine and operate at least two or more constituent elements among the constituent elements included in the server 100 to drive the application program.

According to the exemplary embodiments of the present disclosure, the processor 110 of the server 100 may process an online job related to an online program. Herein, when the processor 110 processes the online job, the processor 110 may process the online job without using a batch system.

Particularly, the processor 110 may process the online job by reading meta-information related to the online job stored in the database 200. More particularly, the processor 110 may process an online transaction associated with the online program by using the meta-information. Herein, the meta-information related to the online job may be generated by statically analyzing the job control language and stored in the database 200 when the migration of the job control language associated with the online program is performed.

That is, the server 100 according to the exemplary embodiments of the present disclosure may process the online program without passing through the batch system, thereby efficiently managing and operating the task.

For example, in the case of abnormal termination of a task process, even if there is no user intervention, the server 100 may read the abnormally terminated process from the database 200. Accordingly, the server 100 of the present disclosure may efficiently cope with the abnormal termination of the task process.

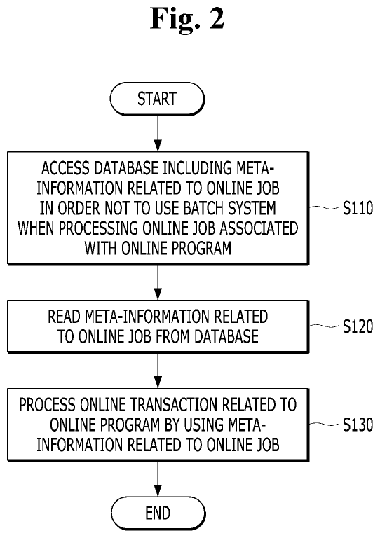

Hereinafter, the method of processing, by the processor 110 of the server 100, the online job associated with the online program will be described below regarding FIGS. 2 to 5.

In the present disclosure, the database 200 may include, for example, a predetermined type of computer system or computing device, such as a microprocessor, a main frame computer, a digital single processor, a portable device, and a device controller. Each of the databases 200 may include a database management system (DBMS) and a persistent storage medium. Further, the database 200 may also be used to be exchangeable with a device for executing a query. However, the present disclosure is not limited thereto.

According to the exemplary embodiments of the present disclosure, the database 200 may store meta-information related to the online job corresponding to the online program. Particularly, the database 200 may store metal information related to the online job in the persistent storage medium. However, the present disclosure is not limited thereto.

In the meantime, the database 200 may allow access to an external server (herein, the server 100) which desires to process a specific online job. Further, the database 200 may allow an external server to access and read meta-information. That is, the database 200 may provide an external server with information corresponding to a query (for example, a query requesting meta-information) received from the external server.

In the present disclosure, the main frame 300 is an industry term referring to a large-scale computer manufactured by a large company, such as IBM, and is mainly used in a computing task required for business activities of very large companies, such as large companies and financial institutions, and is formed of a centralized type rather than a distributed computing type. However, the present disclosure is not limited thereto.

In the present disclosure, the open system 400 is an industry term referring to a method of designing hardware (H/W) and software (S/W) so that hardware (H/W) and software (S/W) of different computer manufacturing companies are connectable, and may be divided into fields, such as an operating system and communication, and the open system mentioned herein is a middle-scale computer equipped with an operating system, for example, UNIX or Linux. However, the present disclosure is not limited thereto.

FIG. 2 is a flowchart for describing an example of a method of processing an online job by the server according to exemplary embodiments of the present disclosure.

Referring to FIG. 2, the processor 110 of the server 100 may process an online job related to an online program. Particularly, the processor 110 may access the database 200 including meta-information related to the online job in order not to use a batch system during the processing of the online job (S110). That is, the processor 110 may access the database 200 to obtain meta-information related to the online job.

Herein, the meta-information related to the online job may be generated by statically analyzing a job control language and stored in the database 200 when the migration of the job control language associated with the online program is performed.

The meta-information may include at least one of scheduling information in a transaction unit for processing the online job, information on an execution program related to the online job, location information on the execution program, a dataset name related to the online job, location information on the dataset, information on an allocation method of the dataset, or information on an input/output device to be used. However, the present disclosure is not limited thereto.

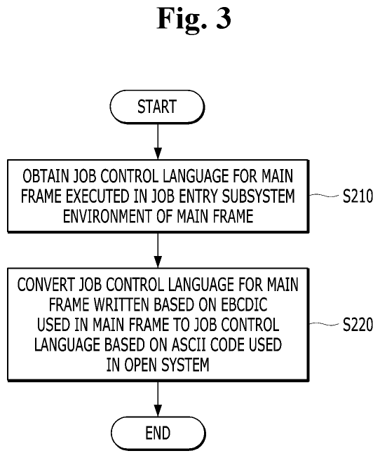

The method of the migration of the job control language will be described below regarding FIG. 3.

When the processor 110 of the server 100 access the database 200, the processor 110 of the server 100 may read meta-information related to the online job from the database 200 (S120). Particularly, the processor 110 may read the meta-information related to the online job by using an online job name.

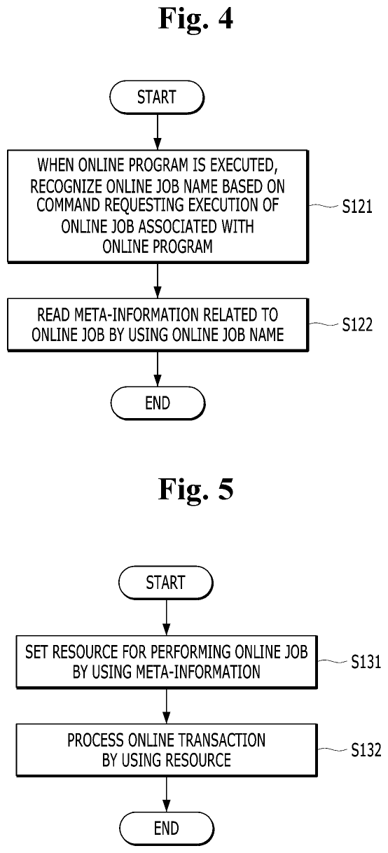

Hereinafter, the method of reading the meta-information by the processor 110 will be described below regarding FIG. 4.

When the processor 110 of the server 100 reads the meta-information related to the online job, the processor 110 of the server 100 may process an online transaction associated with the online program by using the meta-information related to the online job (S130). Particularly, the processor 110 may set a resource for performing the online job by using the meta-information and process the online transaction by using the resource.

Hereinafter, the method of processing the online transaction by the processor 110 will be described below regarding FIG. 5.

According to additional exemplary embodiments of the present disclosure, the processor 110 of the server 100 may detect whether the online program is abnormally terminated. Particularly, the processor 110 may detect whether the online program is abnormally terminated at a predetermined time interval (for example, one minute) after the execution of the online program.

When the processor 110 detects the abnormal termination of the online program, the processor 110 may access the database 200. Further, the processor 110 may re-read the meta-information related to the online job of the online program. Further, the processor 110 may re-process the online transaction related to an abnormally terminated online program by using the meta-information.

That is, when the task process is abnormally terminated, the server 100 of the present disclosure may read the abnormally terminated process from the database 200 even though there is no user intervention. Accordingly, the server 100 of the present disclosure may efficiently cope with even the abnormal termination of the task process.

FIG. 3 is a flowchart for describing an example of the migration method according to exemplary embodiments of the present disclosure.

Referring to FIG. 3, the processor 110 of the server 100 may obtain a job control language for the main frame executed in a job entry subsystem environment of the main frame 300 (S210).

Particularly, the processor 110 may access the main frame 300. Further, the processor 110 may download a job control language original file executed in the job entry subsystem environment of the main frame 300.

The processor 110 may control the job control language for the main frame written based on the Extended Binary Coded Decimal Interchange Code (EBCDIC) used in the main frame 300 to a job control language based on the American Standard Code for Information Interchange Code (ASCII Code) used in the open system (S220).

According to the exemplary embodiments of the present disclosure, a DB2 that is a host of the main frame 300 may generate a control file after performing unload (an operation of serializing data stored in the DB2 and downloading the data in the form of a file). Herein, the control file is the file used for loading (a recovery operation of recovering the extracted file) the data and the file downloaded through the unloading operation to the DB2 again.

In the meantime, a DB2 HPU executed in the open system 400 may generate a control file required for performing the load operation after the unload operation in the same manner. However, there is a grammatical difference of the control file between the main frame 300 and the open system 400, so that the DB2 HPU executed in the open system 400 may not directly use the control file generated in the main frame 300.

Accordingly, the processor 110 may convert a LOAD control syntax designated in a SYSIN of a LOAD JCL in an INSTREAM scheme into the form of ASC FORMAT METHODL, and then additionally convert the corresponding control file according to the grammar of the DB2 HPU of the open system 400.

According to the exemplary embodiments of the present disclosure, a method of designating an input/output file for accessing an external file by a SASHOST used in the open system 400 is different from a file access method of the SASHOST used in the existing main frame 300.

A SASHOST utility of the open system 400 transfers the input/output file in the form of a parameter when calling a program. Accordingly, when the processor 110 calls the SASHOST in the JCL, the processor 110 explicitly designates a DD name used as an input/output value and converts the JCL so that the DD name is transmitted as a parameter when calling the SASHOST.

According to the exemplary embodiments of the present disclosure, in a SyncSort product among the SORT utilities, a negative number expression method of a ZD format is different between the case where the SyncSort product is used in the main frame 300 and the case where the SyncSort product is used in the open system 400. Accordingly, the processor 110 converts the ZD format described in the SORT JCL to the TP format.

In FIG. 3, the processor 110 of the server 100 is described as the example of the main agent performing the migration for the job control language. However, the present disclosure is not limited thereto, the operations S210 and S220 may also be performed by an external management server managing the job control language or a processor of a database system server.

FIG. 4 is a flowchart for describing an example of a method of reading, by the server, meta-information related to an online job in the database according to exemplary embodiments of the present disclosure.

Referring to FIG. 4, when the online program is executed, the processor 110 of the server 100 may recognize an online job name based on a command requesting the execution of the online job associated with the online program (S121). Herein, the command requesting the execution of the online job may include the online job name.

The processor 110 may read meta-information related to the online job by using the online job name (S122).

For example, if the online job name is a first online job name, the processor 110 may read the first meta-information which is mapped to the first online job name and is stored in the database 200.

That is, the database 200 may map the online job name and the online job corresponding to the online job name and store the meta-information related to the online job. For example, the database 200 may store the meta-information related to the online job in the form, such as “first online job name—first online job—meta-information of first online job”.

FIG. 5 is a flowchart for describing an example of a method of processing, by the server, an online transaction related to an online program by using meta-information related to an online job according to exemplary embodiments of the present disclosure.

Referring to FIG. 5, the processor 110 of the server 100 may set a resource for performing the online job using the meta-information (S131).

Particularly, the processor 110 may extract the resource corresponding to the online job from the meta=information.

The resource corresponding to the online job may mean, for example, all of the resources used in the open system 400. For example, the resource may include a dataset and an execution program.

In the meantime, the processor 110 may process the online transaction by using the resource (S132).

Particularly, the processor 110 may process the online transaction by executing the execution program included in the resource corresponding to the online job.

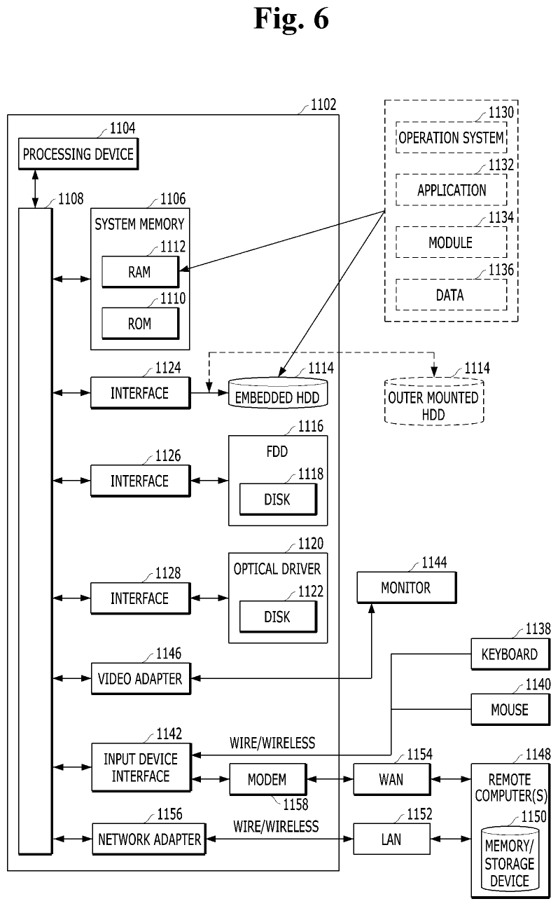

FIG. 6 is a simple and general schematic diagram illustrating an example of a computing environment in which exemplary embodiments of the present disclosure are implementable.

The present disclosure has been generally described concerning a computer-executable command executable in one or more computers, but those skilled in the art will appreciate well that the present disclosure may be implemented in combination with other program modules and/or in a combination of hardware and software.

In general, a module in the present specification includes a routine, a procedure, a program, a component, a data structure, and the like performing a specific task or implementing a specific abstract data form. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini-computer, and a main frame computer.

The exemplary embodiments of the present disclosure may be carried out in a distributed computing environment, in which certain tasks are performed by remote processing devices connected through a communication network. In the distributed computing environment, a program module may be positioned in both a local memory storage device and a remote memory storage device.

The computer generally includes various computer readable media. A computer-accessible medium may be a computer readable medium regardless of the kind of medium, and the computer readable medium includes volatile and non-volatile media, transitory and non-non-transitory media, portable and non-portable media. As a non-limited example, the computer readable medium may include a computer readable storage medium and a computer readable transport medium.

The computer readable storage medium includes volatile and non-volatile media, transitory and non-transitory media, portable and non-portable media constructed by a predetermined method or technology, which stores information, such as a computer readable command, a data structure, a program module, or other data. The computer readable storage medium includes a random access memory (RAM), a read-only memory (ROM), electrically erasable and programmable ROM (EEPROM), a flash memory, or other memory technologies, a compact disc (CD)-ROM, a digital video disk (DVD), or other optical disk storage devices, a magnetic cassette, a magnetic tape, a magnetic disk storage device, or other magnetic storage devices, or other predetermined media, which are accessible by a computer and are used for storing desired information, but is not limited thereto.

The computer readable transport medium generally includes all of the information transport media, such as a carrier wave or other transport mechanisms, which implement a computer readable command, a data structure, a program module, or other data in a modulated data signal. The modulated data signal means a signal, of which one or more of the characteristics are set or changed to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a specific time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer-executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of compute readable storage media, such as a zip drive, a magnetic cassette, a flash memory card, and a cartridge, may also be used in the illustrative operation environment, and the predetermined medium may include computer-executable commands for performing the methods of the present disclosure.

A plurality of program modules including an operating system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated well that the present disclosure may be implemented by several commercially usable operation systems or a combination of operating systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a gamepad, a stylus pen, a touch screen, and the like. The foregoing and other input devices are frequently connected to the processing device 1104 through an input device interface 1142 connected to the system bus 1108, but maybe connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a server computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are generally in an office and a company and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication server on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 operates communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or maybe simply ad hoc communication between at least two devices.

The Wi-Fi enables a connection to the Internet and the like even without a wire. Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or maybe operated in a product including both bands (dual bands).

Those skilled in the art will appreciate that the various illustrative logical blocks, modules, processors, means, circuits, and algorithm operations described concerning the exemplary embodiments disclosed herein may be implemented by electronic hardware (for convenience, called “software” herein), various forms of program or design code, or a combination thereof. To clearly describe the compatibility of the hardware and the software, various illustrative components, blocks, modules, circuits, and operations are generally illustrated above concerning the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using standard programming and/or engineering technology. A term “manufactured article” includes a computer program, a carrier, or a medium accessible from a predetermined computer readable device. For example, the computer readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. A term “machine-readable medium” includes a wireless channel and various other media, which are capable of storing, holding, and/or transporting a command(s) and/or data, but is not limited thereto.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

What is claimed is:

1. A computer readable medium containing a computer program, wherein the computer program includes commands which cause a computer to execute steps, the steps comprising:
accessing a database including meta-information related to an online job in order not to use a batch system when processing the online job associated with an online program;
reading the meta-information related to the online job from the database; and
processing an online transaction related to the online program by using the meta-information related to the online job.

2. The computer readable medium of claim 1, wherein when migration of a job control language associated with the online program is performed, the meta-information related to the online job is generated by analyzing the job control language statically and stored in the database.

3. The computer readable medium of claim 2, wherein the migration is performed by the following migration steps, the migration steps comprising:
obtaining a job control language for a main frame executed in a job entry subsystem environment of the main frame; and
converting the job control language for the main frame written based on the EBCDIC(Extended Binary Coded Decimal Interchange Code) used in the main frame to a job control language based on ASCII(American Standard Code for Information Interchange) code used in an open system.

4. The computer readable medium of claim 2, wherein the meta-information related to the online job comprises at least one of scheduling information in a transaction unit for processing the online job, information on an execution program related to the online job, location information on the execution program, a dataset name related to the online job, location information on the dataset, information on an allocation method of the dataset or information on an input/output device to be used.

5. The computer readable medium of claim 1, wherein the reading the meta-information related to the online job from the database comprises:
when the online program is executed, recognizing an online job name based on a command requesting execution of the online job associated with the online program; and
reading the meta-information related to the online job by using the online job name.

6. The computer readable medium of claim 5, wherein the reading the meta-information related to the online job by using the online job name comprises:
if the online job name is a first online job name, reading first meta-information that is mapped to the first online job name and stored in the database.

7. The computer readable medium of claim 1, wherein the processing an online transaction associated with the online program by using the meta-information related to the online job comprises:
setting a resource for performing the online job by using the meta-information; and
processing the online transaction by using the resource.

8. The computer readable medium of claim 7, wherein the setting a resource for performing the online job by using the meta-information comprises:
extracting the resource corresponding to the online job from the meta-information; and
processing the online transaction by executing an execution program included in the resource.

9. The computer readable medium of claim 1, wherein the steps further comprise:
detecting whether the online program is abnormally terminated;
re-reading the meta-information related to an online job of the online program by accessing the database when abnormal termination of the online program is detected; and
re-processing the online transaction related to an abnormally terminated online program by using the meta-information.

10. A method for processing an online job, comprising:
accessing a database including meta-information related to an online job in order not to use a batch system when processing the online job associated with an online program;
reading the meta-information related to the online job from the database; and
processing an online transaction related to the online program by using the meta-information related to the online job.

11. The method of claim 10, wherein when migration of a job control language associated with the online program is performed, the meta-information related to the online job is generated by analyzing the job control language statically and stored in the database.

12. The method of claim 11, wherein the migration is performed by the following migration steps, the migration steps comprising:
obtaining a job control language for a main frame executed in a job entry subsystem environment of the main frame; and
converting the job control language for the main frame written based on the EBCDIC(Extended Binary Coded Decimal Interchange code) used in the main frame to a job control language based on ASCII(American Standard Code for Information Interchange) code used in an open system.

13. The method of claim 11, wherein the meta-information related to the online job comprises at least one of scheduling information in a transaction unit for processing the online job, information on an execution program associated with the online job, location information on the execution program, a dataset name related to the online job, location information on the dataset, information on an allocation method of the dataset or information on an input / output device to be used.

14. The method of claim 10, wherein the reading the meta-information related to the online job from the database comprises:
when the online program is executed, recognizing an online job name based on a command requesting execution of the online job associated with the online program; and
reading the meta-information related to the online job by using the online job name.

15. The method of claim 14, wherein the reading the meta-information related to the online job by using the online job name comprises:
if the online job name is a first online job name, reading first meta-information that is mapped to the first online job name and stored in the database.

16. The method of claim 10, wherein the processing an online transaction related to the online program by using the meta-information related to the online job comprises:
setting a resource for performing the online job by using the meta-information; and
processing the online transaction by using the resource.

17. The method of claim 16 wherein the setting a resource for performing the online job by using the meta-information comprises:
extracting the resource corresponding to the online job from the meta-information; and
processing the online transaction by executing an execution program included in the resource.

18. The method of claim 10, further comprising:
detecting whether the online program is abnormally terminated;
re-reading the meta-information related to an online job of the online program by accessing the database when abnormal termination of the online program is detected; and
re-processing the online transaction related to an abnormally terminated online program by using the meta-information.
